(19) United States
(12) Patent Application Publication
(10) Pub. No.: US 2018/0150070 A1
(43) Pub. Date: May 31, 2018

(54) PORTABLE INSPECTION AND CONTROL DEVICE

(71) Applicant: Caterpillar Inc., Peoria, IL (US)

(72) Inventors: Lonny Eric Johnson, Peoria, IL (US); Harsh P. Shah, Elk Grove Village, IL (US); Matthew C. Nelson, Edwards, IL (US)

(73) Assignee: Caterpillar Inc., Peoria, IL (US)

(21) Appl. No.: 15/363,788

(22) Filed: Nov. 29, 2016

(51) Int. Cl. G05B 23/02; G06F 21/31; G06T 7/00; G06T 19/00

(52) U.S. Cl. CPC G05B 23/0216; G06F 21/31; G06T 7/001; G06T 2207/30164; G05B 2219/36542; G05B 2219/32014; G06T 19/006

(57) ABSTRACT

An inspection assembly for a machine is provided. The inspection assembly includes a portable computing device. The inspection assembly further includes a controller associated with the portable computing device. The controller is configured to determine a set of activities related to inspection of the machine to be performed by an operator using the portable computing device. The set of activities are related to inspection of machine parts during a physical walk around the machine performed by the operator. The controller is configured to determine if the operator has completed performing the set of activities. The controller is configured to selectively augment a set of controls for operating the machine on the portable computing device based on the determination of the completion of the set of activities.

### TECHNICAL FIELD

The present disclosure relates to an inspection assembly, and more particularly to the inspection assembly having augmented reality capability for inspection of parts.

### BACKGROUND

Prior to operating a machine, for example, a wheel loader, it may be required for an operator of the machine to do a physical walk around the machine to check or inspect certain parts of the machine. It may be recommended to perform this physical inspection of the parts of the machine on a regular basis. For example, the operator may be required to perform the inspection on a daily basis prior to operating the machine.

The parts required for inspection and a sequence of performing the inspection may vary based on an experience level of the operator, a type of the machine, and so on. In some cases, it may be mandatory for the operator to perform the required inspections by physically inspecting the machine parts prior to operating the machine. Sometimes, the operator may skip the entire inspection routine or portions of the inspection routine. In such situations, it may be difficult to track such activities of the operator. In other cases, even if the operator has visited all inspection areas, it may still be difficult to determine if the operator has successfully performed the desired inspections.

U.S. Pat. No. 9,286,736 describes an automobile including a self-diagnostic monitoring server. The vehicle monitoring system includes an automobile system comprising a self-powered motor vehicle used for transportation. The vehicle system includes a sensor system arranged on a set of components of the automobile system and coupled to an energy providing system in the automobile system to be provided with energy by said energy providing system, said sensor system obtaining data about at least one property for each component of the set of components of the automobile system and converting the data into signals. The vehicle system includes a communication system in the automobile system. The vehicle system includes an analytics system to receive the data and determine a state of each component of the automobile system based on the at least one property of each component.

### SUMMARY OF THE DISCLOSURE

In one aspect of the present disclosure, an inspection assembly for a machine is provided. The inspection assembly includes a portable computing device. The inspection assembly further includes a controller associated with the portable computing device. The controller is configured to determine a set of activities related to inspection of the machine to be performed by an operator using the portable computing device. The set of activities are related to inspection of machine parts during a physical walk around the machine performed by the operator. The controller is configured to determine if the operator has completed performing the set of activities. The controller is configured to selectively augment a set of controls for operating the machine on the portable computing device based on the determination of the completion of the set of activities.

In another aspect of the present disclosure, a method for inspection of a machine is provided. The method includes determining, by a controller of a portable computing device, a set of activities related to inspection of the machine to be performed by an operator using the portable computing device. The set of activities are related to inspection of machine parts during a physical walk around the machine performed by the operator. The method includes determining, by the controller, if the operator has completed performing the set of activities. The method further includes selectively augmenting, by the controller, a set of controls for operating the machine on the portable computing device based on the determination of the completion of the set of activities.

In yet another aspect, a system is provided. The system includes a machine having a set of physical controls for operating the machine. The system also includes a portable computing device adapted to be worn or used by an operator of the machine during inspection of the machine. The system includes a controller of the portable computing device. The controller is configured to determine a set of activities related to the inspection of the machine to be performed by the operator. The set of activities are related to inspection of machine parts during a physical walk around the machine performed by the operator. The controller is configured to determine if the operator has completed performing the set of activities. The controller is configured to selectively augment a set of controls for operating the machine on the portable computing device based on the determination of the completion of the set of activities.

Other features and aspects of this disclosure will be apparent from the following description and the accompanying drawings.

### BRIEF DESCRIPTION OF THE DRAWINGS

FIG. 1 is a perspective view of an exemplary machine and an operator inspecting the machine, according to various concepts of the present disclosure;

FIG. 2 is a block diagram of an inspection assembly associated with the machine of FIG. 1, according to various concepts of the present disclosure; and

FIG. 3 is a perspective view of an inside of an operator cabin of the machine of FIG. 1, according to various concepts of the present disclosure;

FIG. 4 is a schematic view of an augmented reality display viewable by the operator within the operator cabin of FIG. 3, according to various concepts of the present disclosure; and

FIG. 5 is a flow chart of a method of inspecting a machine, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

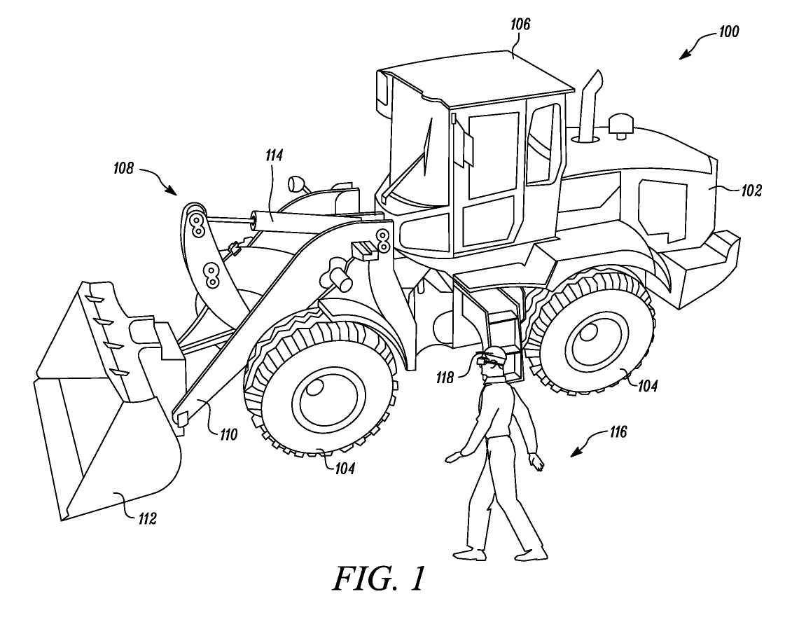

FIG. 1 represents an exemplary machine 100, according to one embodiment of the present disclosure. More specifically, the machine 100 is embodied as a wheel loader. Alternatively, the machine 100 may include any other earthmoving machine such as a motor grader, an excavator, a wheel tractor scraper, etc. Further, the present disclosure may also be utilized on other products or systems requiring physical inspection such as turbines, reciprocating engines, and so on.

Referring to FIG. 1, the machine 100 includes a frame 102. A powertrain and/or a drivetrain (not shown) is also provided on the machine 100 for the production and transmission of motive power. The powertrain includes a power source (not shown) and is located within an enclosure of the machine 100. The power source may include one or more engines or other power delivery systems such as batteries, hybrid engines, and the like.

The machine 100 also includes wheels 104 for the purpose of mobility. The powertrain may also include a torque converter, a transmission system inclusive of gearing, a drive shaft and other known drive links provided between the power source and the wheels 104 for the transmission of the motive power. Further, the machine 100 has an operator cabin 106 that houses controls for operating the machine 100.

As shown in FIG. 1, a linkage assembly 108 is attached to the frame 102 of the machine 100. The linkage assembly 108 includes a lift arm 110. An implement, such as a bucket 112, is pivotally coupled to the lift arm 110. It may be noted that the linkage assembly 108 and the implement of the machine 100 may vary based on the type of machine 100 or the type of operation or task required to be carried out by the machine 100.

During operation of the machine 100, the lift arm 110 and the bucket 112 may be moved to different positions in order to perform excavation and dumping tasks. The movement of the lift arm 110 and/or the bucket 112 is controlled by hydraulic and/or pneumatic cylinders 114, which are coupled to these parts. Accordingly, based on the movement of the lift arm 110 and the bucket 112, the machine 100 may perform different operations such as excavating, loading, and dumping.

An operator 116 is shown standing proximate to the machine 100. The operator 116 has worn a portable computing device 118. This portable computing device 118 is a headset or helmet. In other embodiments, the portable computing device 118 may include glasses or any other suitable device that can be worn or used by the operator 116 and supports augmented reality applications. In yet other embodiments, the portable computing device 118 may include a smartphone, a tablet, a netbook, a laptop, and so on. After wearing the portable computing device 118, the operator 116 walks around the machine 100 to perform a physical walk around inspection of different parts of the machine 100 prior to operating the machine 100. For example, it may be required for the operator 116 to inspect a condition of some machine parts, for example condition of the wheels 104 of the machine 100, lights (not shown) present on the machine 100, and so on as part of a daily inspection routine.

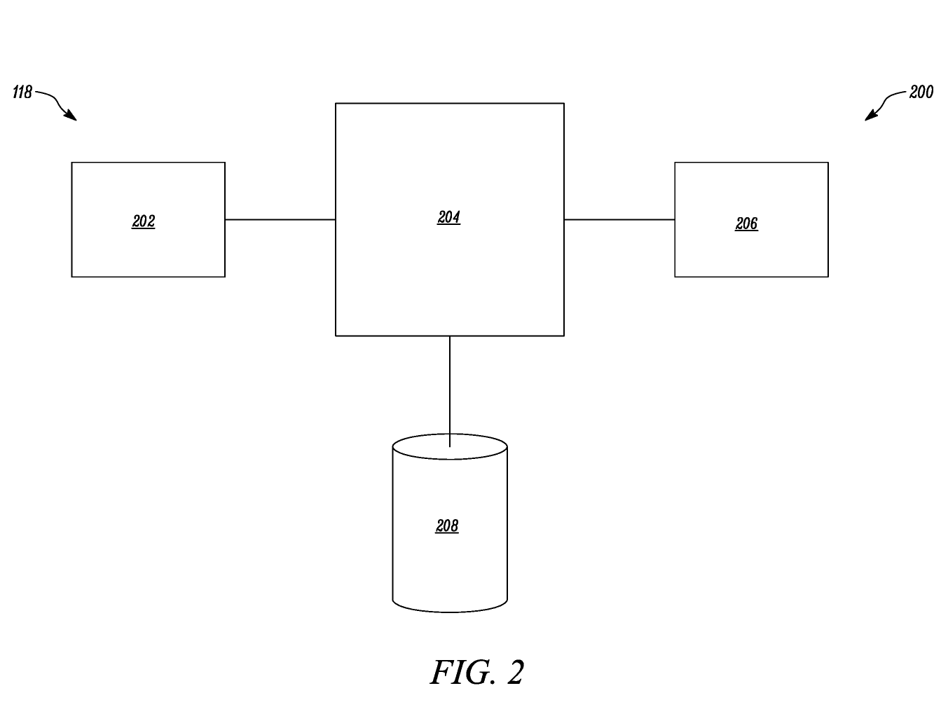

Referring to FIGS. 1 and 2, an inspection assembly 200 is illustrated. The inspection assembly 200 includes the portable computing device 118 having a sensor assembly 202, a controller 204, and a display 206. The portable computing device 118 is a wireless device that can be easily mounted on a head portion of the operator 116 and includes a glass or plastic lens portion that extends downwards onto eyes of the operator 116. The lens serves as the display 206 for overlay of an augmented reality image on a field of view of the operator 116 viewable through the lens. The controller 204 may be embedded in the portable computing device 118. The controller 204 may include any known processing unit, graphical processing unit, and/or holographic processing unit. The portable computing device 118 also includes a power unit and other circuitry not described herein.

The portable computing device 118 may operate as an independent device and can be connected to a wireless communication network, such as Internet, Internet of Things, LAN, WAN, etc. through Wi-Fi, Wi-Fi Direct, Bluetooth or any other suitable connections means. In some embodiments, after wearing the portable computing device 118, the operator 116 may need to switch on the portable computing device 118 and log into a profile that is created specifically for the operator 116. The profile may include operator information and details of access rights, permissions for operating certain types of machines based on a level of experience of the operator 116, operator preferences for operating the given machine, and so on.

This information is stored in a database 208 associated with the portable computing device 118 and may be retrieved by the controller 204 of the portable computing device 118 that is coupled to the database 208. The database 208 may be present within the portable computing device 118 or may include any external data source, online data repository, or data cloud that can be accessed by the controller 204 of the portable computing device 118 over the wireless communication network.

Based on a type of the machine 100 that the operator 116 needs to operate and the access rights of the operator 116 for the given machine 100, the portable computing device 118 may download or retrieve a set of activities that the operator 116 needs to perform for inspecting the machine 100 from the database 208. These set of activities may be based on skills of the operator 116, type of the machine 100, access rights of the operator 116, and/or based on if the operator 116 is authorized or trained to operate the machine 100. The set of activities may include a checklist of the inspection activities that the operator 116 needs to perform prior to entering the machine 100.

For example, the operator 116 may first need to check a certain machine part and then inspect another machine part. In some embodiments, a sequence in which the activities of inspection need to be performed may be pre-stored in the database 208 by an owner of the database 208. The controller 204 of the portable computing device 118 may retrieve and determine the set of activities that need to be performed by the operator 116 for inspecting the machine 100. The set of activities may include a list of the machine parts that the operator 116 needs to inspect during the physical walk around. In some embodiments, the sequence of performing the set of activities may also be retrieved by the controller 204. This information related to the set of activities may be retrieved from the database 208 by the controller 204.

Referring to FIG. 2, the portable computing device 118 includes the sensor assembly 202 provided thereon. The sensor assembly 202 may include an image capturing assembly, an infrared sensor, a gyroscope and other sensors required for generating three dimensional real time data maps of surroundings of the operator 116 wearing or using the portable computing device 118. Referring to FIGS. 1 and 2, as the operator 116 wearing or using the portable computing device 118 walks around the machine 100 to perform the inspection of the machine parts, the sensor assembly 202 may capture image feed of the inspection of the machine parts being conducted by the operator 116 during the walk around.

The controller 204 performs image analysis on the image feed of the inspection and compares different frames or views of the image feed with corresponding predetermined inspection feed retrieved from the database 208, in order to determine if the said activity of the set of activities is successfully completed based on a match in the comparison of the feeds. Accordingly, the controller 204 ascertains that one of the set of activities is complete from the set of activities required for the inspection.

In some embodiments, the controller 204 may overlay augmented reality images on the display 206 of the portable computing device 118 that may serve as visual cues to guide the operator 116 to a next inspection area or the next machine part based on the predetermined sequence of performing the set of activities. For example, arrows may be overlaid on the display 206 to guide the operator 116 to the next inspection area or the machine part. While performing the physical walk around, the operator 116 may interact with the image capturing assembly of the portable computing device 118 to take images of the machine part undergoing inspection. Further, if the controller 204 determines that the machine part does not match expectations and fails the inspection based on the comparison of the feeds, the controller 204 may log and flag such information of the machine part for corrective actions to be taken.

As the operator 116 walks around the machine 100, the controller 204 may monitor a progress of the operator 116 in the set of activities, and may proceed to iteratively check if the operator 116 has successfully performed the next activity based on the comparison of the feeds. The controller 204 repeats these steps for all of the activities in the predetermined sequence of performing the set of activities. These processing steps are performed by the controller 204 on a real-time basis based on a movement of the operator 116 around the machine 100.

The controller 204 may perform processing steps of operator and inspection tracking, object recognition, and image analysis on the image feed using machine learning and other known algorithms. The controller 204 further determines if the set of activities have been completed by the operator 116 based on success in completing each of the set of activities in the predetermined sequence. Further, the controller 204 may maintain a log or record of the activities from the set of activities that have been successfully completed by the operator 116, such that the log is continuously refreshed and updated by the controller 204 based on real-time completion of the activities as the operator 116 performs the walk around.

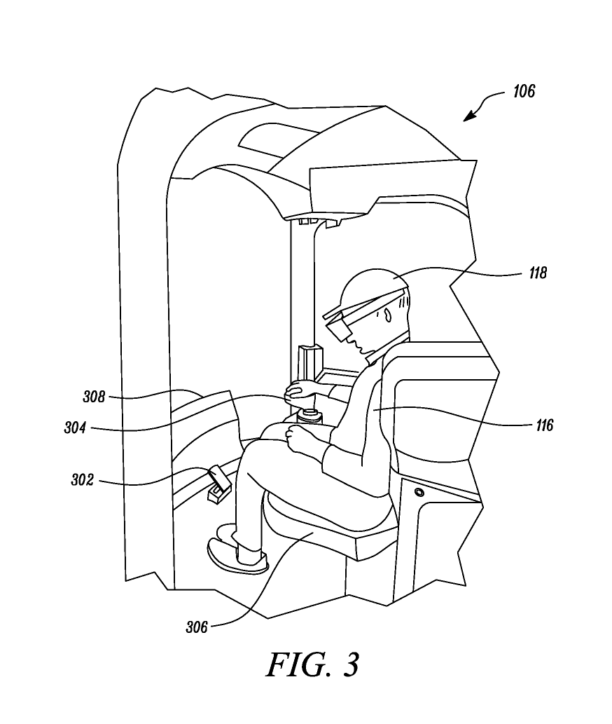

After the operator 116 has completed the physical walk around, the operator 116 sits in the operator cabin 106 of the machine 100. Referring to FIG. 3, the operator cabin 106 includes a set of physical controls such as, pedals 302 and a joystick 304 that is attached to an operator seat 306. Other physical controls may be absent from the operator cabin 106. As can be seen, a dashboard 308 of the operator cabin 106 is physically empty and does not have any control panels, button, or switches. It should be noted that the set of physical controls retained in the operator cabin 106 in the accompanying figures are exemplary and do not limit the scope of the present disclosure.

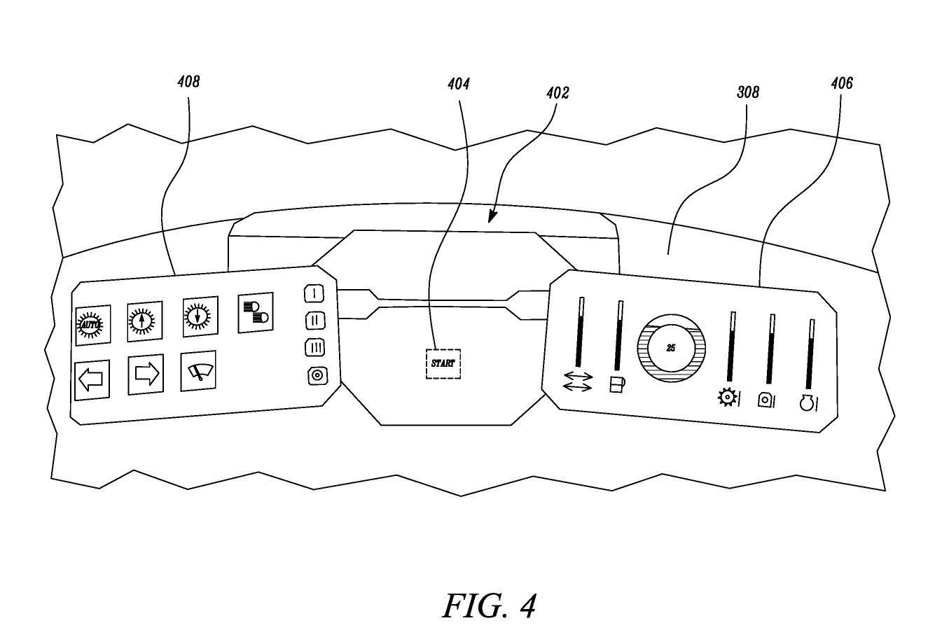

Referring to FIG. 4, when the operator 116 sits in the operator cabin 1106 and looks down at the dashboard 308, the controller 204 selectively overlays a set of controls 402 on the display 206 of the portable computing device 118. In some embodiments, based on access rights and permissions granted to the given operator 116, the controller 204 determines if the operator 116 who is wearing or using the portable computing device 118, logged into the portable computing device 118, and currently seated in the operator seat 306 is authorized to operate the machine 100 as per the profile of the operator 116 for the given machine 100 retrieved from the database 208.

The identity of the operator 116 may be known to the controller 204 based on login information provided by the operator 116 at the time of wearing or using the portable computing device 118. The type of machine 100 may be identified by the controller 204 based on a user input provided at the time of wearing or using the portable computing device 118. Alternatively, the operator 116 may be requested to scan a quick response code provided on the machine 100 at the beginning of the inspection for identification of the type of the machine 100. In one embodiment, if the operator 116 is not authorized to operate the machine 100, the controller 204 may augment an error message, informing the operator 116 that he is not authorized to operate the machine 100, on the display 206 of the portable computing device 118.

Further, the controller 204 determines if the operator 116 has successfully completed all of the set of activities required to compete the desired inspection of the machine 100. This determination takes place based on comparing the log of the activities that the operator 116 has successfully performed and the list of the set of activities that the operator 116 is expected to perform. In some example, the controller 204 may also determine if the set of activities have been performed in the predetermined sequence or not. If the set of activities is determined as completed by the controller 204, then as shown in FIG. 4, the controller 204 overlays the set of controls 402 as augmented reality images on the display 206 of the portable computing device 118.

These set of controls 402 includes a start control 404 for starting the machine 100. The start control 404 is displayed as a start button in the accompanying figures. The start button is only augmented on the dashboard 308 of the machine 100 if the controller 204 determines that the operator 116 has successfully completed the set of activities for inspection of the machine 100. Alternatively, the start control 404 may be augmented on the display 206 of the portable computing device 118 in any other form, shape, or representation. The operator 116 may interact with the start control 404 by a touch or tap action using his fingers, thereby triggering an activation or switch on of an engine of the machine 100. It should be noted that a human machine interface is suitably implemented by the system which translates the tap action of the operator 116 on the start control 404 to machine command signals to an electronic control unit of the machine 100 for starting the machine 100.

Referring to FIG. 4, the controller 204 may selectively augment other controls on the dashboard 308 of the machine 100 if the operator 116 has performed the set of activities required for the inspection of the machine 100. For example, a first control panel 406 may include visual indicators providing an indication of a current speed of the machine 100, coolant temperature, engine RPM, and so on. Further, a second control panel 408 may also be augmented on the dashboard 308. The second control panel 408 includes interactive buttons that are augmented on the display 206 of the portable computing device 118. By interacting with these buttons through the touch or tap action, the operator 116 may control switching on headlights of the machine 100, turn control, wiper controls, HVAC controls, and/or controls for other machine functionalities. The appearance of the augmented reality images on the display 206, the placement and functionality of the augmented reality dashboard described herein is exemplary and does not limit the scope of the present disclosure.

In some situations, if the controller 204 determines that the operator 116 has not successfully completed the inspection of the machine 100, the controller 204 may prevent the start control 404 from being augmented on the display 206 of the portable computing device 118. Instead, the controller 204 may augment an error message on the display 206 of the portable computing device 118 informing the operator 116 that the necessary inspection activities have not been completed. In some cases, based on the comparison between the expected activities to be performed and the set of activities performed by the operator 116, the controller 204 may augment a list of activities that are yet to be performed by the operator 116 to successfully complete the inspection.

The controller 204 may embody a single microprocessor or multiple microprocessors. Numerous commercially available microprocessors can be configured to perform the functions of the controller 204. The controller 204 may include all the components required to run an application such as, for example, a memory, a secondary storage device, and a processor, such as a central processing unit or any other means known in the art. Various other known circuits may be associated with the controller 204, including power supply circuitry, signal-conditioning circuitry, solenoid driver circuitry, communication circuitry, and other appropriate circuitry.

### INDUSTRIAL APPLICABILITY

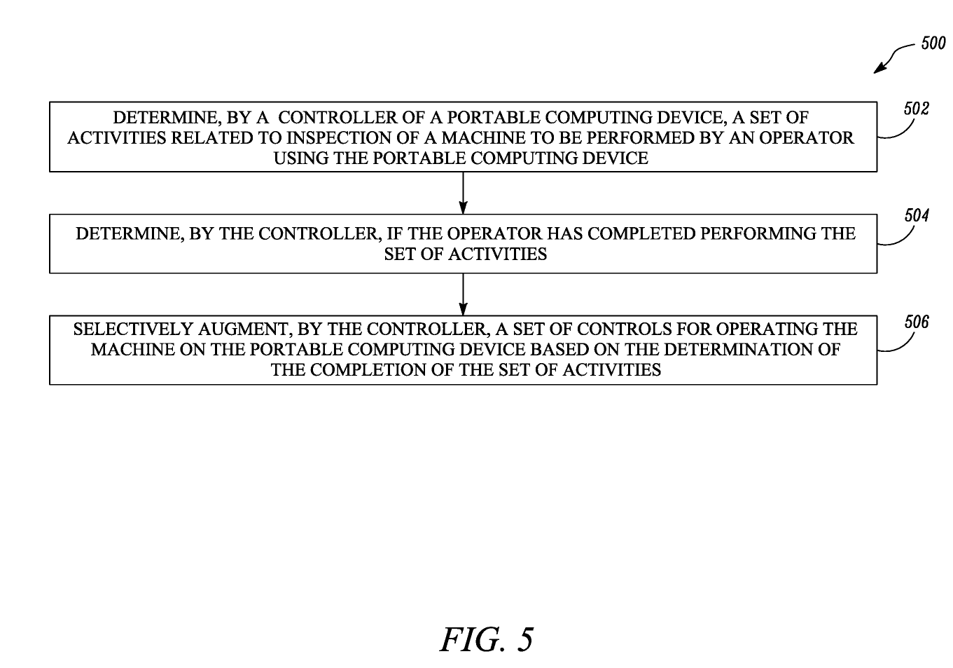

The present provides a system for providing selective control rights to the operator 116 based on completion of the required set of inspection activities. Referring to FIG. 5, a method 500 of operation of the inspection assembly 200 is provided. At step 502, the controller 204 determines the set of activities related to inspection of the machine 100 that need to be performed by the operator 116 using the portable computing device 118. At step 504, the controller 204 determines if the operator 116 has completed performing the set of activities. At step 506, the controller 204 selectively augments the set of controls 402 for operating the machine 100 on the portable computing device 118 based on the determination of the completion of the set of activities.

The present disclosure provides a robust solution for ensuring that the walk around inspection is completed by operator 116 prior to operating the machine 100. If the operator 116 has not completed the required inspection activities, the system denies the operator 116 rights to start the machine 100. Further, the system uses the same piece of hardware that is the augmented reality portable computing device 118 for monitoring the inspection activity and providing the selective start control functionality to the operator 116. The inspection assembly 200 is system agnostic and can be easily implemented for the inspection of any machine 100 or other system requiring inspection prior to use thereof.

Further, the same portable computing device 118 may be used to inspect a fleet of different types of the machines 100 on a worksite. The operator 116 may login to the portable computing device 118 and download or retrieve inspection routines specific to the operator 116 for the given machine 100 or system undergoing the inspection. Further, user preferences may be stored for each of the operators 116, such that the augmented set of controls 402 may be customized specific to the needs of the given operator 116. This may save time for the operator 116 in resetting the controls within the operator cabin 106, thereby improving overall productivity of the system.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An inspection assembly for a machine, the inspection assembly comprising:
a portable computing device; and
a controller associated with the portable computing device, the controller configured to:
determine a set of activities related to inspection of the machine to be performed by an operator using the portable computing device, wherein the set of activities are related to inspection of machine parts during a physical walk around the machine performed by the operator;
determine if the operator has completed performing the set of activities; and
selectively augment a set of controls for operating the machine on the portable computing device based on the determination of the completion of the set of activities.

2. The inspection assembly of claim 1, wherein the portable computing device is a helmet, glasses, headset capable of displaying an augmented reality image thereon.

3. The inspection assembly of claim 1, wherein the controller is embedded in the portable computing device.

4. The inspection assembly of claim 1, wherein the controller is further configured to determine if the operator is authorized to operate the machine based on access rights of the operator.

5. The inspection assembly of claim 1, wherein the set of controls includes a start control for starting the machine based on the completion of the set of activities.

6. The inspection assembly of claim 1, wherein the portable computing device further includes an image capturing assembly configured to capture an image feed of the physical walk around by the operator for inspecting the machine parts.

7. The inspection assembly of claim 6, wherein the controller is further configured to:
compare the image feed of the physical walk around by the operator with a predetermined inspection feed; and
determine if any one of the set of activities is completed based on the comparison.

8. The inspection assembly of claim 7, wherein the controller is configured to iteratively perform the compare and determine steps based on a movement of the operator around the machine.

9. The inspection assembly of claim 1, wherein the controller is further configured to augment visual cues on the portable computing device to guide the operator for the physical walk around based on a predetermined sequence of performing the set of activities.

10. The inspection assembly of claim 1, wherein the controller is configured to augment an error message on the portable computing device if the set of activities is not completed by the operator.

11. The inspection assembly of claim 1, wherein the controller is configured to selectively augment the set of controls on a dashboard present within an operator cab of the machine.

12. A method for inspection of a machine, the method comprising:
determining, by a controller of a portable computing device, a set of activities related to inspection of the machine to be performed by an operator using the portable computing device, wherein the set of activities are related to inspection of machine parts during a physical walk around the machine performed by the operator;
determining, by the controller, if the operator has completed performing the set of activities; and
selectively augmenting, by the controller, a set of controls for operating the machine on the portable computing device based on the determination of the completion of the set of activities.

13. The method of claim 12 further comprising determining, by the controller, if the operator is authorized to operate the machine based on access rights of the operator.

14. The method of claim 10, wherein the set of controls includes a start control for starting the machine based on the completion of the set of activities.

15. The method of claim 12 further comprising capturing, by an image capturing assembly of the portable computing device, an image feed of the physical walk around by the operator for inspecting the machine parts.

16. The method of claim 15 further comprising:
comparing, by the controller, the image feed of the physical walk around by the operator with a predetermined inspection feed; and
determining, by the controller, if any one of the set of activities is completed based on the comparison.

17. The method of claim 16 further comprising iteratively performing, by the controller, the comparison and determination steps based on a movement of the operator around the machine.

18. The method of claim 12 further comprising augmenting, by the controller, visual cues on the portable computing device to guide the operator for the physical walk around based on a predetermined sequence of performing the set of activities.

19. The method of claim 12 further comprising augmenting, by the controller, an error message on the portable computing device if the set of activities is not completed by the operator.

20. A system comprising:
a machine having a set of physical controls for operating the machine;
a portable computing device adapted to be used for inspection of the machine; and
a controller of the portable computing device, the controller configured to:
determine a set of activities related to the inspection of the machine to be performed by the operator, wherein the set of activities are related to inspection of machine parts during a physical walk around the machine performed by the operator;
determine if the operator has completed performing the set of activities; and
selectively augment a set of controls for operating the machine on the portable computing device based on the determination of the completion of the set of activities.
